(19) United States
(12) Patent Application Publication
(10) Pub. No.: US 2026/0300766 A1
(43) Pub. Date: Oct. 1, 2026

(54) METHOD, APPARATUS, DEVICE AND STORAGE MEDIUM FOR INFORMATION PROCESSING

(71) Applicants: Beijing Zitiao Network Technology Co., Ltd., Beijing (CN); Lemon Inc., Grand Cayman (KY)

(72) Inventors: Xin Xie, Singapore (SG); Junyuan Qi, Beijing (CN); Yang Liu, Beijing (CN); Pengcheng Cai, Beijing (CN); Tianzi Yuan, Los Angeles, CA (US); Koken Ishii, Los Angeles, CA (US); Yingdi Sun, Beijing (CN); Qingjing Liu, Beijing (CN)

(21) Appl. No.: 19/478,242

(22) PCT Filed: May 31, 2024
(86) PCT No.: PCT/CN2024/096832

§ 371 Date: Oct. 23, 2025

(30) Foreign Application Priority Data
Jun. 1, 2023 (CN) 202310644162.8

(51) Int. Cl. G06N 5/022

(52) U.S. Cl. CPC G06N 5/022

(57) ABSTRACT

Embodiments of the disclosure provide a method, apparatus, device, and a storage medium for information processing. The method includes: based on an interaction mode triggered in a plurality of interaction modes of a first digital assistant, presenting an interaction area of a first user corresponding to the triggered interaction mode and a first digital assistant, wherein the interaction modes of the first user and the first digital assistant in different interaction modes are different. Therefore, diversified interaction between the user and the digital assistant may be realized, and flexible switching may be carried out among different interaction modes according to needs.

This application claims the benefit of Chinese Patent Application No. 202310644162.8, filed on Jun. 1, 2023, entitled “METHOD, APPARATUS, DEVICE AND STORAGE MEDIUM FOR INFORMATION PROCESSING,” the entire content of which is incorporated herein by reference.

### FIELD

Example embodiments of the present disclosure generally relate to the field of computers, and in particular, to a method, apparatus, device and computer-readable storage medium for information processing.

### BACKGROUND

With the rapid development of internet technologies, the internet has become an important platform for people to obtain and share content, and users may access the internet through terminal devices to enjoy various Internet services. Terminal devices present corresponding content and realize interaction with users and provide services for users through the user interface of applications. Therefore, a colorful interactive interface of the application is an important means to enhance the user experience. With the development of information technology, various terminal devices may provide people with various services in work and life. For example, applications that provide services can be deployed in terminal devices. Terminal devices or applications may provide users with digital assistant-type functions to assist users in using terminal devices or applications. How the flexibility of the interaction between the user and the digital assistant can be improved is a current technical issue to be explored.

### SUMMARY

In a first aspect of the present disclosure, a method of information processing is provided. The method includes: presenting, based on a triggered interaction mode of a plurality of interaction modes of a first digital assistant, an interaction area between a first user and the first digital assistant corresponding to the triggered interaction mode, wherein interaction manners of the first user and the first digital assistant in different interaction modes are different.

In a second aspect of the present disclosure, an apparatus for information processing is provided. The apparatus includes: an interaction presenting module configured to present, based on a triggered interaction mode of a plurality of interaction modes of a first digital assistant, an interaction area between a first user and the first digital assistant corresponding to the triggered interaction mode; wherein interaction manners of the first user and the first digital assistant in different interaction modes are different.

In a third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the device to perform the method of the first aspect.

In a fourth aspect of the present disclosure, a computer-readable storage medium is provided. The medium has a computer program stored thereon, and the computer program is executable by a processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIGS. 2A-2D illustrate schematic diagrams of example client interfaces for a multi-interaction mode of a user with a digital assistant according to some embodiments of the present disclosure;

FIGS. 3A-3F illustrate schematic diagrams of example client interfaces for a multi-interaction mode of a user with a digital assistant according to some embodiments of the present disclosure;

FIG. 4A to FIG. 4B illustrate schematic diagrams of examples of interaction history records for other interaction modes in a first interaction mode according to some embodiments of the present disclosure;

FIGS. 5A-5H illustrate schematic diagrams of example entry controls for a digital assistant in a second interaction mode according to some embodiments of the present disclosure;

FIG. 6 illustrates a flowchart of a process for information processing according to some embodiments of the present disclosure;

FIG. 7 illustrates a block diagram of an apparatus for information processing according to some embodiments of the present disclosure; and

FIG. 8 illustrates an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It may be understood that, before the technical solutions disclosed in the embodiments of the present disclosure are used, the related users shall be informed of the type, scope of use, use scenario, etc. of the information involved in the present disclosure and obtain the authorization of the related users in accordance with the relevant laws and regulations and by appropriate means. Among them, the relevant users may include any type of right subjects, such as individuals, enterprises, and organizations.

For example, when an active request of a user is received, prompt information is sent to the related user to explicitly prompt the related user, and the operation requested to be performed will need to obtain and use the information of the related user. Thereby, the related user can independently choose whether or not to provide information to software or hardware such as an electronic device, an application, a server, or a storage medium that performs the operation of the technical solution of the present disclosure based on the prompt information.

As an optional but non-limiting implementation, in response to receiving an active request of the related user, a manner of sending prompt information to the related user may be, for example, a pop-up window, and prompt information may be presented in a text manner in the pop-up window. In addition, the pop-up window may further carry a selection control for the user to select “agree” or “disagree” to provide personal information to the electronic device.

It should be understood that the foregoing notification and obtaining a user authorization process is merely illustrative, and does not constitute a limitation on implementations of the present disclosure, and other manners of meeting related laws and regulations may also be applied to implementations of the present disclosure.

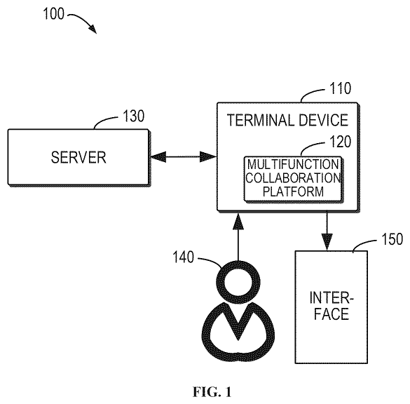

FIG. 1 illustrates a schematic diagram of an example environment 100 in which embodiments of the present disclosure may be implemented. In the example environment 100, a multifunction collaboration platform 120 is installed in the terminal device 110. A user 140 may interact with the multifunction collaboration platform 120 via the terminal device 110 and/or an attachment device of the terminal device 110. The multifunction collaboration platform 120, such as an office collaboration platform (also referred to as an office suite), may provide integration of a plurality of types of functions or components to facilitate people to perform activities such as office and communication. In the multifunctional collaboration platform 120, people may start different functions or components according to needs, to complete corresponding information processing, sharing, communication and the like.

The multifunction collaboration platform 120 may provide integration of a plurality of components to the user 140. These components may serve as component modules in the multifunction collaboration platform 120. The components integrated in the multifunction collaboration platform 120 are sometimes also referred to as “applications,” “components,” and the like. Such components include, but are not limited to, office components, tool components, and the like. As an example, components integrated in the multifunction collaboration platform 120 may include, but are not limited to, one or more of: a chat component (also referred to as an instant messaging component), a document component, an audio and video conference component, a mail component, a calendar component, a schedule component, a task component, a objectives and key results (OKR) component, or the like. It may be understood that various other types of components may also be integrated into the office suite.

In some embodiments, the multifunction collaboration platform 120 may be downloaded as an application and installed on the terminal device 110. In some embodiments, the multifunction collaboration platform 120 may also be accessed in other manners, e.g., through a web page.

In the environment 100 of FIG. 1, if the multifunction collaboration platform 120 is started, the terminal device 110 may present an interface 150 of the multifunction collaboration platform 120. The interface 150 may include various user interfaces that may be provided by the multifunction collaboration platform 120. The interface 150 is also sometimes referred to as a client interface.

In some embodiments, the terminal device 110 communicates with the server 130 to implement provision of services to the multifunction collaboration platform 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.). The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for example purposes only and do not imply any limitation to the scope of the present disclosure.

While some multifunction collaboration platforms are capable of providing integrated functions of different components, the degree of intelligence is insufficient, and content (e.g., documents, tables, appointments, meeting summaries, etc.) in many of the components replies on manual processing without capabilities of automatic generation and collaboration. However, manual information processing is inefficient, duplicative and ineffective, and prone to errors. Many scenarios require searching, understanding and organizing work in huge amounts of data, which adds to the difficulty of manual processing. Moreover, the time cost of manual work in information search, document or meeting record reading is high, and it is inefficient and error-prone in scenarios such as summarization, text writing and computation, reading comprehension, cross-language search, and cross-component content interaction.

In order to provide intelligence, some multifunctional collaboration platforms integrate digital assistant-type functions for interaction with users. However, there are fewer scenarios where digital assistants can be used, and the threshold for effective utilization of the digital assistants is high. Some digital assistants have long trigger paths, and it is difficult to achieve efficient interactions in various task scenarios.

According to embodiments of the present disclosure, an improved scheme for information processing is provided. In an embodiment of the present disclosure, an interaction area between a first user and a first digital assistant corresponding to a triggered interaction mode is presented based on the triggered interaction mode of a plurality of interaction modes of the first digital assistant, where interaction manners of the first user and the first digital assistant in different interaction modes are different. Therefore, diversified interaction between the user and the digital assistant may be realized, and flexible switching may be carried out among different interaction modes according to needs.

Some example embodiments of the present disclosure will be described in detail below with reference to examples of the accompanying drawings.

As described above, in embodiments of the present disclosure, the digital assistant is configured to interact with a user. The digital assistant serves as an intelligent assistant, and has a capability of intelligent dialog and information processing. The digital assistant performs operations in response to instructions input by a user. A client interface for providing a digital assistant may correspond to a single functional application or a multifunction collaboration platform, such as an office suite or other collaboration platform capable of integrating a plurality of components.

In an embodiment of the present disclosure, a plurality of interaction modes for a user and a digital assistant are provided, and the plurality of interaction modes may be flexibly switched. In the case that a certain interaction mode is triggered, a corresponding interaction area is presented to facilitate interaction by the user with the digital assistant. The interaction manners of the user and the digital assistant in different interaction modes are different, which may be flexibly adapted to interaction requirements in different application scenarios.

In some embodiments, the digital assistant as a contact of the user may be included in a contact list of the current user in the office suite, or included in a feed of the chat component. In some embodiments, the user has correspondence with the digital assistant. For example, the first digital assistant corresponds to the first user, the second digital assistant corresponds to the second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service for the first user, the first digital assistant may use its historical interaction information with the first user, data authorized by the first user that may be accessed, current interaction context between the first digital assistant and the first user, and the like. If the first user is an individual or a person, the first digital assistant may be considered a personal digital assistant. It may be understood that, in embodiments of the present disclosure, the first digital assistant is granted with permission on data based on authorization of the first user.

It should be understood that the “unique correspondence” or the like in this disclosure is not intended to limit that the first digital assistant will be updated accordingly based on the interaction process between the first user and the first digital assistant.

In some embodiments, the information processing service specific to the first user may be provided based on historical interaction information between the first user and the first digital assistant and/or a data range specific to the first user. In some embodiments, the historical interaction information of the first user interacting with the first digital assistant in a plurality of interaction modes may be stored in association with the first user. In this way, the first digital assistant may provide, in one of the plurality of interaction modes, a service for the first user based on historical interaction information stored in association with the first user.

Therefore, the degree of freedom of interaction between the first user and the first digital assistant may be improved. For example, when a user interacts with a traditional assistant, a user usually needs to clearly and explicitly express information processing requirements according to a certain requirement. On the contrary, by considering historical interaction information and/or a range of data specific to the user, embodiments of the present disclosure can support the user in expressing information processing requirements by means of a freer and more concise approach, without compromising the quality of the information processing service obtained. In addition, such an approach can improve the information processing accuracy of the first digital assistant. According to such an example implementation, a “unique correspondence” between the first user and the first digital assistant can be established.

In some embodiments, a first interaction mode of the plurality of interaction modes may include an interaction mode based on a chat window, also referred to as a chat mode. In accordance with a first interaction mode of the plurality of interaction modes being triggered, a chat window between the first user and the first digital assistant is presented, and the first user interacts with the first digital assistant through a chat message in the chat window. In the first interaction mode, the first digital assistant may perform a task according to the chat message in the chat window.

In some embodiments, the first interaction mode (i.e., the chat mode) for the first user with the first digital assistant may be invoked or woken up in an appropriate manner (e.g., shortcut key, button, or speech) to present the chat window. The chat window with the first digital assistant may be opened by selecting the first digital assistant. The chat window may include interface elements for information interaction, such as input boxes, message lists, message bubbles, and the like.

In some embodiments, a second interaction mode of the plurality of interaction modes may include an interaction mode based on an operation panel. In accordance with the second interaction mode of the plurality of interaction modes being triggered, the operation panel corresponding to the first digital assistant is presented, and the first user may issue an instruction to the first digital assistant based on the operation panel. In some embodiments, the operation panel may include at least one candidate shortcut instruction. Alternatively, or in addition, the operation panel may include an input control for receiving an instruction. In some embodiments, the operation panel may be presented in the form of a floating window, and thus the second interaction mode is also referred to as a floating window mode in the present disclosure. In the second interaction mode, the first digital assistant may perform the task based on the instruction issued by the first user through the operation panel.

In some embodiments, the second interaction mode (i.e., the floating window mode) for the first user with the first digital assistant may also be invoked or woken up in an appropriate manner (e.g., shortcut key, button, or speech) to present a corresponding operation panel. In some embodiments, in order to trigger the second interaction mode to present the operation panel corresponding to the first digital assistant, an entry control for the first digital assistant may be presented in the target interface area. In response to detecting trigger for the entry control, it may be determined that the second interaction mode is triggered, and the operation panel corresponding to the first digital assistant is presented in the target interface area. There are many ways to trigger the second interaction mode, which will be discussed in more detail below.

In some embodiments, two or more of the plurality of interaction modes may be triggered simultaneously. If the triggered interaction mode includes two or more interaction modes, in a client interface of the first user, respective interaction areas between the first user and the first digital assistant corresponding to the two or more interaction modes may be simultaneously presented. In this way, in different interaction areas of the same client interface, different interaction modes are used to interact with the first digital assistant.

For ease of understanding, the following describes the first interaction mode and the second interaction mode as an example with reference to the accompanying drawings.

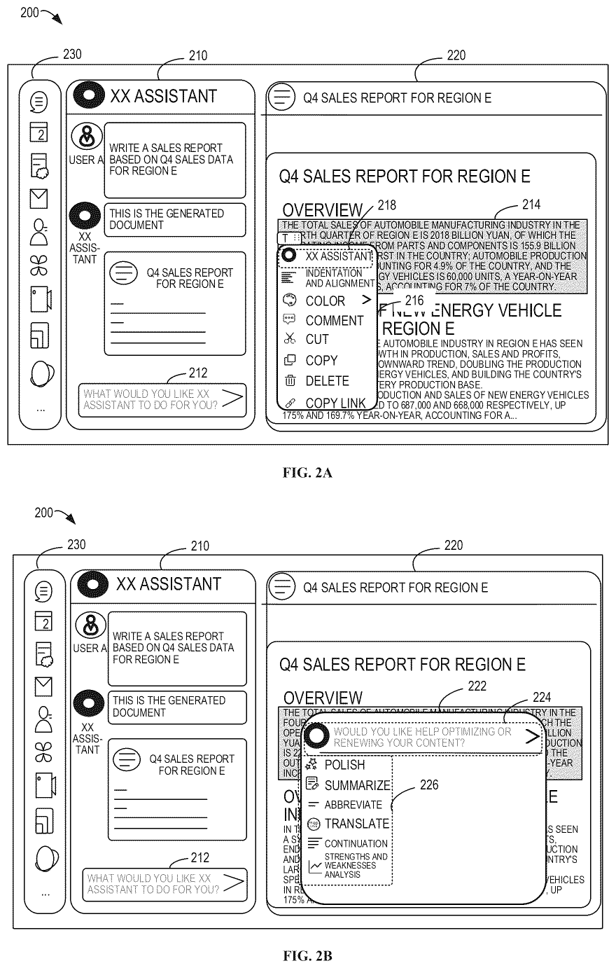

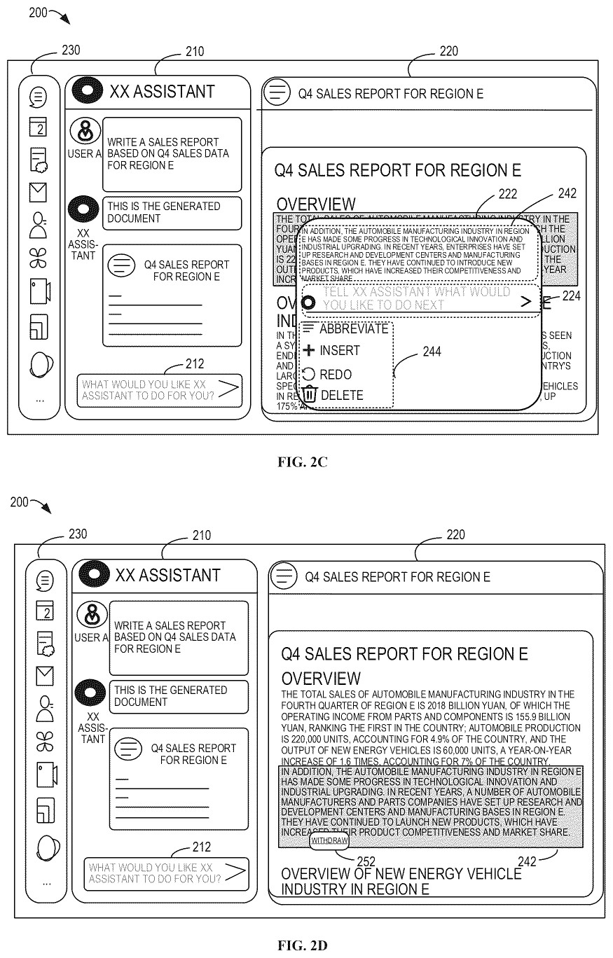

FIGS. 2A-2D illustrate schematic diagrams of example client interfaces of a multi-interaction mode for a user with a digital assistant according to some embodiments of the present disclosure. The first interaction mode is triggered, and a chat window of the first digital assistant (“XX assistant”) with the first user (“user A”) is presented in an area 210 of a client interface 200. In the example of FIG. 2A, the first digital assistant may be considered one of the contacts of the first user, and presented in the feed of the instant messaging component. The first user may enter a chat window by selecting the first digital assistant. Further, the client interface 200 may correspond to a multifunction collaboration platform that integrates a plurality of different types of components. An area 230 of the client interface 200 presents access entry icons for a plurality of components by which corresponding components in the multifunction collaboration platform may be started for operation.

It should be understood that FIG. 2A to FIG. 2D and subsequent figures only show examples of interaction areas, and may also store other interaction areas. In addition, various specific information, icons and the like given in these drawings are merely examples, and are not intended to limit the scope of the embodiments of the present disclosure.

In a chat window of the area 210, the first user may input a message through an input box 212 or by other appropriate means (e.g., speech), and the first digital assistant may provide a reply message based on the input message and in conjunction with the relevant knowledge. The messages in the chat window are typically chat messages. In embodiments of the present disclosure, a chat message (e.g., a chat message of a chat window) in a chat window of the first user and the first digital assistant may be associated with corresponding content in a plurality of components (e.g., a multifunction collaboration platform or an office suite). In some embodiments, the plurality of components may be a plurality of components supported by the multifunction collaboration platform corresponding to the client interface.

As an example, the plurality of components includes, but is not limited to, one or more of: an instant messaging component, a document component, an audio and video conference component, a mail component, a calendar component, a schedule component, a task component, an objectives and key results (OKR) component, and the like. The content associated with the chat message may be text, an image, an audio, a video, or any other suitable format. In the example of FIG. 2A, the chat message input by the first user indicates to create a document, and the chat message replied by the first digital assistant provides a document automatically created by the first digital assistant according to the first user input.

In some embodiments, in the chat window, the content in the component to which each chat message is associated may be partially or fully included in the chat message. For example, the chat message provided by the first digital assistant in FIG. 2A illustrates a portion of the target document (that is, the thumbnail of the target document) in the document component. In some embodiments, the chat message may include an access path or access entry for the content of the associated component, such as a link, view icon, etc., by which the associated content may be accessed.

In some embodiments, content associated with the chat message may be presented in another area of the client interface either automatically or based on a user trigger (e.g., a user selecting a document in the chat message). Specifically, the chat window for the first user and the first digital assistant may be presented in the first area of the client interface, and the target content may be presented in a second area of the client interface. The target content is associated with a first chat message in the chat window and may be content provided by the first component of the multifunction collaboration platform. The second area may be an operable interface provided by the first component, including the target content. In this way, various operation capabilities provided by the first component may be supported in the second area.

As shown in FIG. 2A, a chat window is presented at the area 210 of the client interface 200, and a target document in the document component to which the chat message is associated is presented at an area 220 of the client interface 200. The area 220 may include a document page of the document component. It is noted that the first area including the chat window and the second area including the target content presentation are illustrated in FIG. 2A and other accompanying drawings in a left-right juxtaposition as an example. In other embodiments, the first area and the second area, as well as other areas in the client interface, may be arranged in other ways as desired. By way of example, it is possible to present the second area on the left side and the first area on the right side in the client interface. As a further example, the first area and the second area may also be arranged in a top and bottom partitioned manner, and so forth.

In some embodiments, the target content presented in the second area may vary with changes in the chat message in the chat window. Since the plurality of chat messages in the chat window with the first digital assistant may each be associated with content in one or more of the components, the target content in the second area displayed in a partitional way with the chat window may also change automatically as the chat messages change. Specifically, the target content in the second area is updated by the first digital assistant based on message interactions with the first user in the chat window, such as continue writing the document according to a first user's instructions. In some embodiments, the target content presented in the second area may vary as the first user makes selection in the chat window. That is, the first user may control the target content presented in the second area as needed. For example, the first user may desire to maintain a certain document to which a previous chat message is associated, even if a subsequent chat message in the chat window may have been associated with content of other documents or other components. The selection of the first user is, for example, a click operation, a specific message input in the chat window, and the like.

In some embodiments, in the area where the target content is displayed, another interaction mode of the first digital assistant may also be triggered. Specifically, as shown in FIG. 2A, after a partial content 214 of the target document in the area 220 is selected, a menu 216 may be displayed, including an entry control of the first digital assistant, that is, a “XX assistant” control 218. By triggering the “XX assistant” control 218, an operation panel 222 as shown in FIG. 2B may be presented. The operation panel 222 may include a plurality of candidate shortcut instructions 226 and an input control 224 for receiving an instruction. In the example of FIG. 2B, the input control 224 for receiving an instruction may be an input box that receives a text input. In other examples, the input control for receiving an instruction may alternatively or in addition include other input controls for receiving speech input, image input, and/or video input.

As shown in FIG. 2B, in the client interface 200, an interaction area corresponding to the first interaction mode (that is, the chat mode) and an interaction area corresponding to the second interaction mode (that is, a floating window mode) are simultaneously presented. The first user may interact with the first digital assistant in either area as desired.

In some embodiments, the operation panel corresponding to the first digital assistant in the second interaction mode may be presented in the target interface area corresponding to the target content. For example, in the example of FIG. 2B, the operation panel 222 is presented in the area 220 corresponding to the target document. In this example, the operation panel 222 is presented in the form of a floating window.

It should be understood that the document is taken as an example of the target content in the drawings. In other embodiments, the target content may also include any other appropriate content that the platform can handle, including, but not limited to, audio, video, images, emails, calendars, schedules, tasks, and so on. All the content can be adjusted with the help of the first digital assistant in any interaction mode.

In some embodiments, in the second interaction mode, one or more candidate shortcut instructions in the operation panel may be determined in various appropriate manners to facilitate user selection for processing the target content. In some embodiments, the candidate shortcut instruction may be determined based on at least a portion of the target content, for example, may be determined based on at least a selected portion of the target content. As such, the provided candidate shortcut instruction is particularly suitable for processing the partial content. As shown in FIG. 2B, in the operation panel 222, the candidate shortcut instruction provided includes polishing, summarizing, abbreviating, translating, continuing, strengths and weaknesses analysis, etc., of the selected portion. In some embodiments, the candidate shortcut instruction may be determined based on historical processing operations on the target content, or information related to an interaction for the target content in other interaction modes other than the second interaction mode. By considering the historical context of the target content, the processing requirement of the user on the target content may be better understood, a more suitable shortcut instruction is provided, the time for the user to input the instruction is avoided, and the processing efficiency is improved.

In some embodiments, in the second interaction mode, a processing result for the target instruction is determined based on the detected target instruction for the target content. The target instruction includes a shortcut instruction triggered in the at least one candidate shortcut instruction, or an instruction received through the input control. The target content is adjusted based on the processing result. In some embodiments, in the second interaction mode, the processing result may also be presented in the operation panel. In response to detecting the user confirmation on the processing result, the target content is adjusted based on the processing result. For example, if a trigger for a candidate shortcut instruction “continuation” in the operation panel is detected in FIG. 2B, as shown in FIG. 2C, continuation content 242 is presented in the operation panel 222, and a shortcut instruction 244 for the continuation content 242 may be presented, including “abbreviation”, “insertion”, “redo”, “delete”, and the like. If a trigger for the instruction “insert” is detected, i.e., a user confirmation is detected, the continuation content 242 is inserted into the target document, as shown in FIG. 2D.

FIG. 2B to FIG. 2D are described using an example in which the shortcut instruction in the operation panel is triggered in the second interaction mode. In other examples, the instruction input by the first user through the input control 224 in the operation panel may also be detected. Through the input control, the first user may input any instruction according to the processing requirement. The first digital assistant may be used to understand the user input instruction and determine a corresponding processing result to adjust the target content with the aid of the first digital assistant. The candidate shortcut instruction or the instruction input by the user may be a processing requirement for at least a portion of the target content, or a processing requirement for the target content globally, and the scope of the embodiments of the present disclosure is not limited herein.

In some embodiments, in the second interaction mode, after the target content is adjusted based on the processing result, an undo control for the adjustment may also be provided. For example, the undo control may be presented in association near the portion being adjusted in the target content, or in any suitable location. If the trigger for the undo control is detected, the adjustment to the target content may be canceled. As shown in FIG. 2D, after inserting the continuation content 242, a withdrawal control 252 is further provided to withdraw the insertion operation by the user.

In some embodiments, for some instructions, or for all instructions, the processing result may not be presented in the operation panel, but the target content is adjusted directly based on the processing result. In this way, the first user may quickly and directly see the processing result. If the processing result is not satisfied, the adjustment of the target content may be canceled by issuing a subsequent instruction, or by the provided withdrawal control.

In some embodiments, the first interaction mode (i.e., the chat mode) and the second interaction mode (i.e., the floating window mode) may allow the user to perform different interactions as needed. For example, in an application scenario such as retrieving, analyzing, summarizing, extracting data, optimizing formatting, etc., the first user may perform multi-round dialog with the first digital assistant in the first interaction mode to complete the information processing task. In the following scenario, if a certain portion of the target content needs to be modified, polished, continued, abbreviated, etc., the first user may invoke the first digital assistant at a certain position in the target content, and perform the information processing task in the second interactive mode. In this way, the user may conveniently and quickly interact with the first digital assistant in different interfaces or areas according to requirements, so as to complete the information processing operation by means of the first digital assistant. It should be understood that in either interaction mode, the first user may initiate instructions to the first digital assistant in any appropriate manner, which may be a general processing requirement (e.g., analysis, summarization, formatting) for a single piece of content or a plurality of pieces of content, or may be a specific processing requirement (e.g., polishing, modification, abbreviation, etc.) for a specific portion of the content. The embodiments of the present disclosure are not limited herein with respect to specific instructions in different interaction modes.

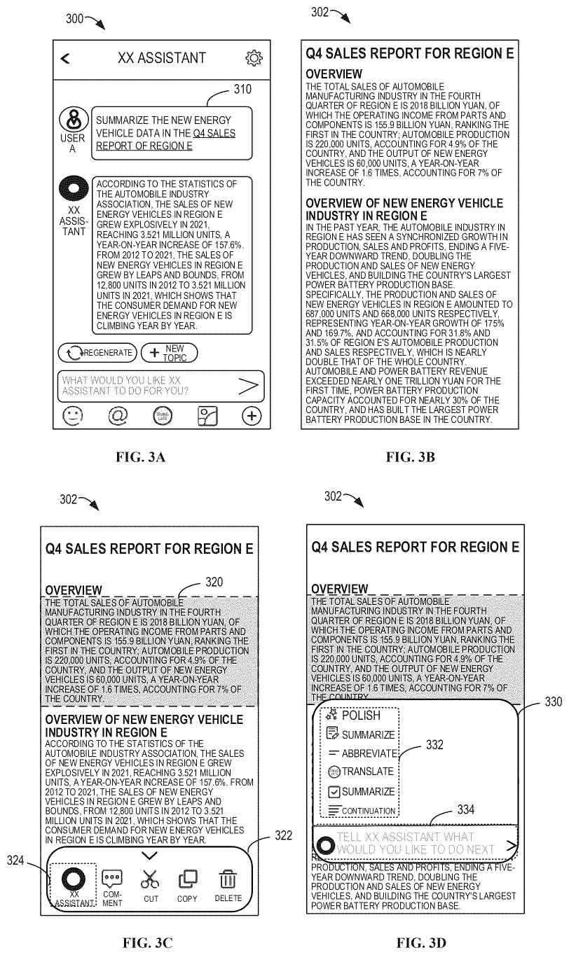

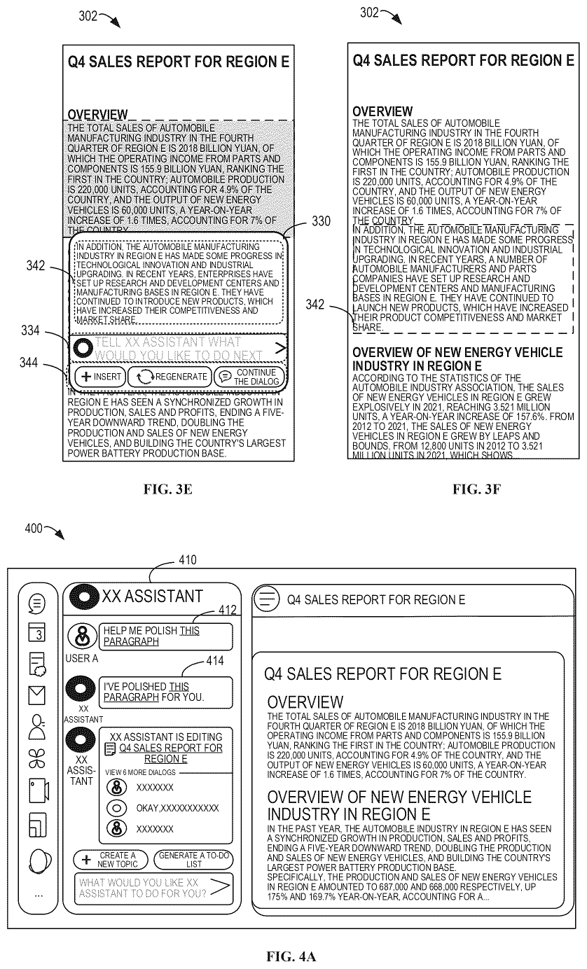

In the examples of FIGS. 2A-2D, examples of simultaneously presenting interaction areas corresponding to two interaction modes in the case where the first interaction mode and the second interaction mode are triggered are shown. In other embodiments, interaction areas corresponding to different interaction modes may also be presented in different client interfaces. FIGS. 3A-3F illustrate schematic diagrams of example client interfaces for a multi-interaction mode between a user and a digital assistant according to some embodiments of the present disclosure. In FIG. 3A, a first interaction mode (that is, the chat mode) is triggered, and a chat window corresponding to the first digital assistant is presented in the client interface 300.

In some cases, the first user triggers presentation of the target content, such as by clicking on a chat message 310 in the chat window. A client interface 302 as shown in FIG. 3B is present. The target document is presented in the client interface 302. In the client interface 302, the first user may trigger a second interaction mode with the first digital assistant in an appropriate manner. As shown in FIG. 3C, by selecting a partial content 320 in the target document, a menu 322 is presented, which includes an entry control of the first digital assistant, that is, a “XX assistant” control 324. By triggering the control 324, an operation panel 330 as shown in FIG. 3D is presented. The operation panel 330 may include a plurality of candidate shortcut instructions 332 and an input control 334 for receiving an instruction. If a trigger for a candidate shortcut command “continuation” in the operation panel is detected in FIG. 3D, as shown in FIG. 3E, continuation content 342 is presented in the operation panel 330, and a shortcut instruction 344 for the continuation content 342 may be presented, including ‘insert’, ‘regenerate’, ‘continue dialog’, and the like. If a trigger for the instruction “insert” is detected, i.e., a user confirmation is detected, then the continuation content 342 is inserted into the target document, as shown in FIG. 3F.

The interaction between the first user and the first digital assistant in different interaction modes is discussed above. In addition to the chat mode and the floating window mode, there may be other interaction modes or interaction manners of the first user and the first digital assistant.

As described above, respective historical interaction information of the first user interacting with the first digital assistant in the plurality of interaction modes is stored in association with the first user. In this way, in one of the plurality of interaction modes, the first digital assistant provides a service for the first user based on the historical interaction information stored in association with the first user. In some embodiments, in the first interaction mode, the first digital assistance performs a task based on the chat message in the chat window, by using the information related to the interaction between the first user and the first digital assistant in the further interaction mode other than the first interaction mode as a context. Similarly, in some embodiments, in the second interaction mode, the first digital assistant performs a task based on the instruction issued by the first user through the operation panel by using the information related to the interaction between the first user and the first digital assistant in a further interaction mode other than the second interaction mode as the context. In other words, the first digital assistant supports interacting with the first user through different interaction modes in different triggering scenarios, but the historical interaction information in the different interaction modes can be jointly considered as a context for the subsequent task processing, regardless of the interaction mode under which the subsequent task processing is triggered. In this way, the intelligence of the first digital assistant as well as the uniqueness for the first user can be significantly provided, enabling the first digital assistant to provide the user with processing results that satisfy the requirements.

Considering that the first interaction mode is the chat mode in which the chat window generally records historical interaction information, in some embodiments, the information related to interaction between the first user and the first digital assistant in a further interaction mode other than the first interaction mode may be further presented in the chat window corresponding to the first interaction mode. In this way, an interaction status between the first user and the first digital assistant in the plurality of interaction modes may be recorded in the chat window. In some embodiments, the interaction-related information presented in the chat window may include descriptions of operations performed in other interaction modes, and may include, for example, an indication of an instruction issued by the first user in the other interaction mode, and/or an indication of the result of the execution of the first digital assistant in response to the instruction, and the like.

Specifically, if the target instruction for the target content is detected in the second interaction mode and the processing result for the target instruction is determined, the target message may be presented in the chat window corresponding to the first interaction mode. The target message at least indicates the processing result.

In some embodiments, the target message presented in the chat window includes a first chat message corresponding to the first user and a second chat message corresponding to the first digital assistant. The first chat message indicates a target instruction, and the second chat message indicates a processing result. In this way, interaction-related information in other interaction modes (e.g., a second interaction mode) can be presented in the form of one or more rounds of chats between the first user and the first digital assistant.

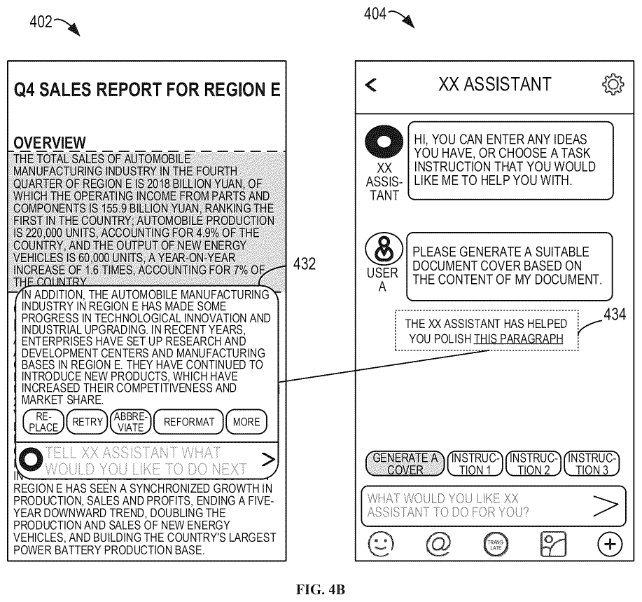

FIG. 4A illustrates a schematic diagram of an example of an interaction history record of other interaction modes in a first interaction mode according to some embodiments of the present disclosure. As shown in FIG. 4A, a chat window corresponding to the first user and the first digital assistant in the first interaction mode is presented in an area 410 of a client interface 400. A chat message 412 corresponding to the first user indicates the instruction “help me polish this paragraph” issued by the first user in the other interaction modes, and a chat message 414 corresponding to the first digital assistant indicates the result of the processing determined by the first digital assistant in the other interaction modes, i.e., “I've polished this paragraph for you”. These chat messages record the interaction between the first user and the first digital assistant in the other interaction modes.

In some embodiments, the target message presented in the chat window may include a system message in the chat window. The system message is not presented as a chat message corresponding to the first user or the first digital assistant in the chat window. FIG. 4B illustrates a schematic diagram of an example of an interaction history record of other interaction modes in a first interaction mode according to some embodiments of the present disclosure. In the example of FIG. 4B, it is assumed that in a client interface 402, the first digital assistant polishes a portion of the target document based on an instruction issued on an operation panel 432 in the second interaction mode. After the first interaction mode is triggered, a system message 434 is presented in the chat window corresponding to a client interface 404, which records the results of the first digital assistant's processing of the target content.

In some embodiments, the target message presented in the chat window may include an access link for the processing result. The access link is configured to link to a portion of the target content that is related to the processing result. For example, in the example of FIG. 4A or FIG. 4B, “this paragraph” in messages 412, 414, and 434 has an access link for which a click may lead to jump to the portion of the target content that is polished. The provision of the access link may facilitate the first user to quickly access the processed content from the target message in the chat window as needed.

In some embodiments, after the target message is presented in the chat window corresponding to the first interaction mode, a reply to a chat message input by a user may be further determined in the first interaction mode and based at least on the target message. In other words, the target message may be used as the historical interaction information and is conveniently referenced in the first interaction mode. For example, the first user may continue to initiate a chat for the target message in the chat window, to request the first digital assistant to continue performing other adjustments or processing on the target content to which the target message is connected or a portion thereof. The first digital assistant may directly understand the processing requirements of the first user.

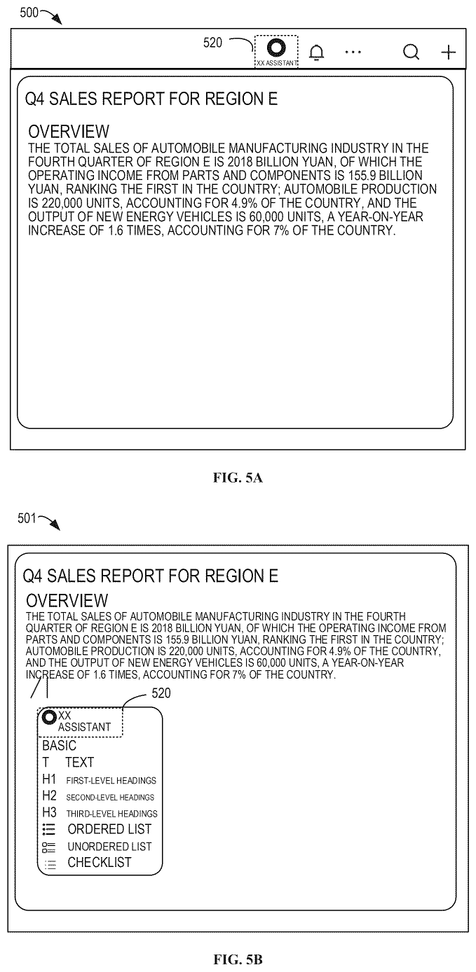

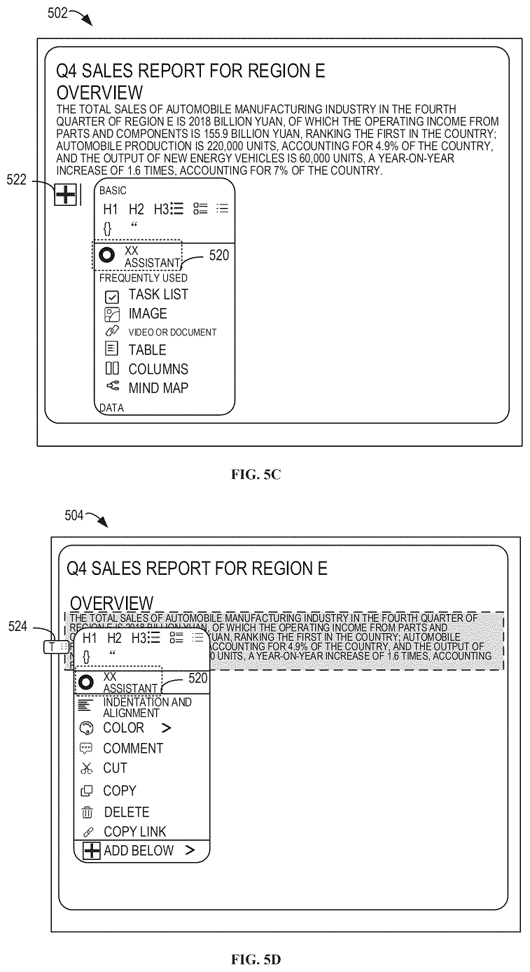

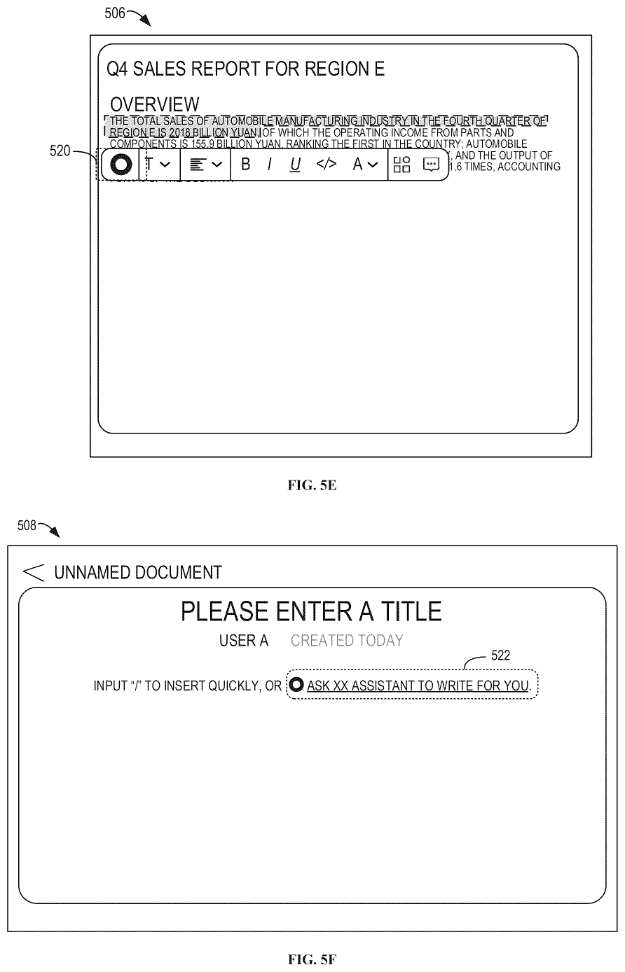

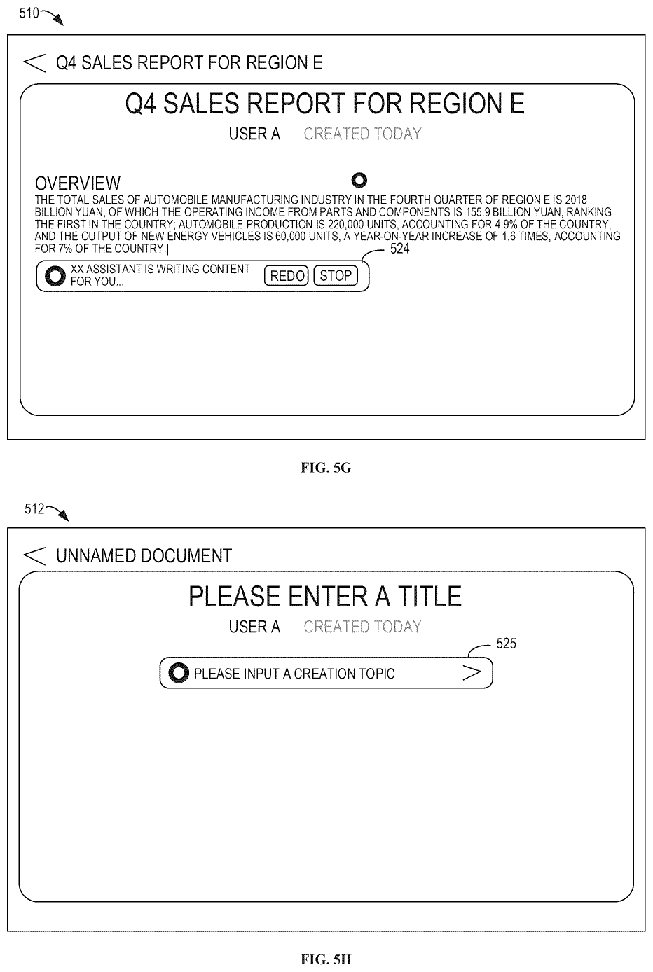

In the above embodiments, at least a portion of the target content is selected to present an entry control corresponding to the first digital assistant so as to trigger the second interaction mode. As mentioned above, there may also be more triggering manners for the second interaction mode. FIGS. 5A-5H illustrate schematic diagrams of example entry controls of a digital assistant in the second interaction mode according to some embodiments of the present disclosure.

In some embodiments, the entry control corresponding to the first digital assistant is fixedly displayed at a predetermined position of the target interface area. As shown in FIG. 5A, a target interface area corresponding to the target content is presented in the client interface 500, and an entry control 520 corresponding to the first digital assistant is presented at a predetermined position of the target interface area, such as a menu position. Thus, when the target interface area corresponding to the target content is presented, the first user may trigger the entry control at the predetermined position as needed to trigger the second interaction mode corresponding to the first digital assistant.

In some embodiments, the entry control corresponding to the first digital assistant may be presented in the target interface area in response to a predetermined operation. The predetermined operation may be any suitable operation, including the selection of portion of the content described above in connection with FIGS. 2A-2D and 3A-3F. In some examples, the predetermined operation may also include inputting a predetermined symbol in the target interface area or the target content, a hover operation in the predetermined area, and the like. For example, in a client interface 501 of FIG. 5B, in response to inputting “/” in a target document, a menu may be presented including an entry control 520 corresponding to the first digital assistant. In a client interface 502 of FIG. 5C, in response to a hover operation in a predetermined area of the target document, a control 522 is presented, where a hover operation on the control 522 will further trigger the display of a menu including the entry control 520 corresponding to the first digital assistant. In a client interface 504 of FIG. 5D, in response to a hover operation on a paragraph in the target document, a control 524 is presented, and a hover operation on the control 524 will further trigger the display of a menu including the entry control 520 corresponding to the first digital assistant. In a client interface 506 of FIG. 5E, in response to a portion of the target document being selected, a menu including the entry control 520 corresponding to the first digital assistant is presented.

In some embodiments, if a type of the target content is a predetermined type, the entry control is embedded into the target content in the target interface area. The predetermined type may be set as needed, for example, may be a type of content that is predetermined to be specifically required to trigger the first digital assistant to assist in processing. In some embodiments, the predetermined type may include, for example, a type of blank content (for example, a blank document), or only a content type of the title.

As shown in FIG. 5F, a blank document is presented at a client interface 508 in which the entry control 522 corresponding to the first digital assistant is directly embedded. In some embodiments, based on a predetermined type, the entry control corresponding to the first digital assistant may also be configured to support triggering a corresponding instruction. For example, in FIG. 5F, by triggering the entry control 522, a “write for me” instruction may be triggered to request the first digital assistant to help writing a document. In a client interface 510 shown in FIG. 5G, if the target document is a document that only includes a title, by triggering the entry control, the first digital assistant may write the content of the document based on the title, and present an operation panel 524, which includes an input control and a number of candidate shortcut commands, such as “Redo”, “Stop”, etc. In some examples, if the target content does not include a title, as in a client interface 512 shown in FIG. 5H, after triggering the entry control, an operation panel 525 of the first digital assistant may be presented, which includes an input control to prompt the user to input a subject of the document.

It should be understood that FIGS. 5A to 5H only illustrate example presentation methods for an entry control directed at a first digital assistant in an interface area corresponding to the target content. The entry control corresponding to the first digital assistant may also be configured for other presentation modes according to the needs of the actual application, and the embodiments of the present disclosure are not limited herein.

It should be understood that some embodiments of the present disclosure are described above with reference to specific examples in the accompanying drawings, but these specific examples are not intended to limit the scope of the embodiments of the present disclosure. The described embodiments may also be implemented in various other variations.

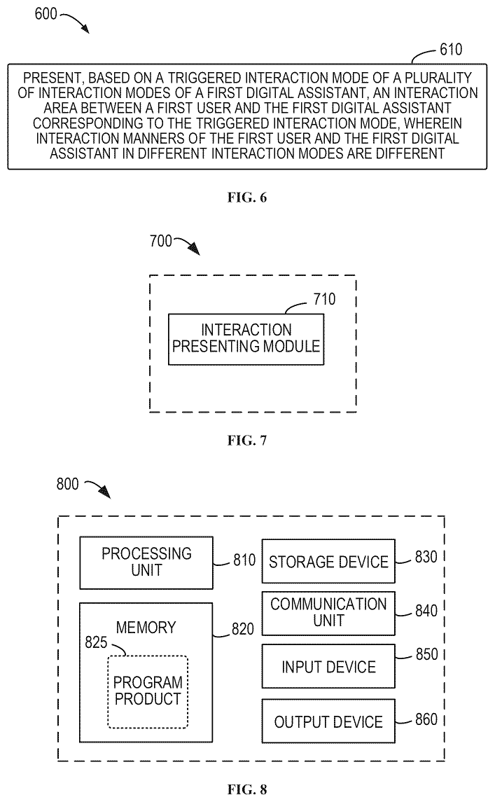

FIG. 6 illustrates a flowchart of a process 600 for information processing according to some embodiments of the present disclosure. The process 600 may be implemented at the terminal device 110. For ease of discussion, the process 200 will be described with reference to the environment 100 of FIG. 1.

At block 610, the terminal device 110 presents, based on a triggered interaction mode of a plurality of interaction modes of a first digital assistant, an interaction area between a first user and the first digital assistant corresponding to the triggered interaction mode, where interaction manners of the first user and the first digital assistant in different interaction modes are different.

In some embodiments, presenting the interaction area between the first user and the first digital assistant corresponding to the triggered interaction mode includes: simultaneously presenting, in a client interface of the first user, respective interaction areas between the first user and the first digital assistant corresponding to two or more interaction modes, in accordance with the triggered interaction mode including the two or more interaction modes.

In some embodiments, respective historical interaction information of the first user interacting with the first digital assistant in the plurality of interaction modes is stored in association with the first user; and in one of the plurality of interaction modes, the first digital assistant provides a service for the first user based on the historical interaction information stored in association with the first user

In some embodiments, presenting the interaction area between the first user and the first digital assistant corresponding to the triggered interaction mode includes: presenting a chat window between the first user and the first digital assistant, in accordance with a first interaction mode of the plurality of interaction modes being triggered, the first user interacting with the first digital assistant through a chat message in the chat window

In some embodiments, the process 600 further includes: presenting information related to interaction between the first user and the first digital assistant in a further interaction mode in the chat window corresponding to the first interaction mode, where the further interaction mode is an interaction mode other than the first interaction mode among the plurality of interaction modes.

In some embodiments the information related to the interaction includes a description of an operation performed in the further interaction mode.

In some embodiments, in the first interaction mode, the first digital assistance executes a task based on the chat message in the chat window, by using the information related to the interaction between the first user and the first digital assistant in the further interaction mode as a context, where the further interaction mode is an interaction mode other than the first interaction mode among the plurality of interaction modes.

In some embodiments, presenting the interaction area between the first user and the first digital assistant corresponding to the triggered interaction mode includes: presenting an operation panel corresponding to the first digital assistant, in accordance with a second interaction mode of the plurality of interaction modes being triggered, the operation panel including at least one of: at least one candidate shortcut instruction, or an input control for receiving an instruction, the first user issuing an instruction to the first digital assistant based on the operation panel.

In some embodiments, in the second interaction mode, the first digital assistant executes a task based on the instruction issued by the first user through the operation panel, by using the information related to the interaction between the first user and the first digital assistant in a further interaction mode as a context, where the further interaction mode is an interaction mode other than the second interaction mode among the plurality of interaction modes.

In some embodiments, presenting the operation panel corresponding to the first digital assistant includes: presenting an entry control for the first digital assistant in a target interface area corresponding to a target content; determining that the second interaction mode is triggered, in response to detecting triggering for the entry control; and presenting the operation panel corresponding to the first digital assistant in the target interface area.

In some embodiments, the entry control is fixedly displayed at a predetermined position of the target interface area. In some embodiments, the entry control is presented in the target interface area in response to a predetermined operation. In some embodiments, the entry control is embedded into the target content in the target interface area in accordance with a type of the target content being a predetermined type.

In some embodiments, the at least one candidate shortcut instruction in the operation panel is determined based on at least one of: at least a portion of the target content, a historical processing operation on the target content, or information related to an interaction for the target content in a further interaction mode, where the further interaction mode is an interaction mode other than the second interaction mode among the plurality of interaction modes.

In some embodiments, the process 600 further includes: determining, in the second interaction mode, a processing result for a target instruction detected for the target content based on the target instruction, the target instruction including a triggered shortcut instruction of the at least one candidate shortcut instruction, or an instruction received through the input control; and adjusting the target content based on the processing result In some embodiments, adjusting the target content based on the processing result includes: presenting the processing result in the operation panel; and adjusting the target content based on the processing result, in response to detecting a user confirmation for the processing result.

In some embodiments, the process 600 further includes: providing a withdrawal control for the adjustment.

In some embodiments, the process 600 further includes: in accordance with the plurality of interaction modes including a first interaction mode, and an interaction area between the first user and the first digital assistant in the first interaction mode being a chat window, presenting a target message in the chat window corresponding to the first interaction mode, the target message at least indicating the processing result.

In some embodiments, the target message includes a first chat message corresponding to the first user and a second chat message corresponding to the first digital assistant, the first chat message indicating the target instruction, the second chat message indicating the processing result. In some embodiments, the target message includes a system message in the chat window.

In some embodiments, the target message includes an access link of the processing result, the access link being configured to link to a portion of the target content related to the processing result.

In some embodiments, the process 600 further includes: determining, in the first interaction mode and based at least on the target message, a reply to a chat message input by a user.

In some embodiments, the target content includes one or more of the following: a document, an audio, a video, an image, an email, a calendar, a schedule, and a task.

FIG. 7 is a schematic structural block diagram of an information processing apparatus 700 according to some embodiments of the present disclosure. The apparatus 700 may be implemented or included in the terminal device 110. The various modules/components in the apparatus 700 may be implemented by hardware, software, firmware, or any combination thereof.

The apparatus 700 includes an interaction presenting module 710 configured to present, based on a triggered interaction mode of a plurality of interaction modes of a first digital assistant, an interaction area between a first user and the first digital assistant corresponding to the triggered interaction mode, where interaction manners of the first user and the first digital assistant in different interaction modes are different.

In some embodiments, the interaction presenting module 710 includes: a simultaneous presenting module configured to simultaneously present, in a client interface of the first user, respective interaction areas between the first user and the first digital assistant corresponding to two or more interaction modes, in accordance with the triggered interaction mode including the two or more interaction modes.

In some embodiments, respective historical interaction information of the first user interacting with the first digital assistant in the plurality of interaction modes is stored in association with the first user; and in one of the plurality of interaction modes, the first digital assistant provides a service for the first user based on the historical interaction information stored in association with the first user.

In some embodiments, the interaction presenting module 710 includes: a first interaction presenting module configured to present a chat window between the first user and the first digital assistant, in accordance with a first interaction mode of the plurality of interaction modes being triggered, the first user interacting with the first digital assistant through a chat message in the chat window.

In some embodiments, the apparatus 700 further includes: an interaction information presenting module configured to present, information related to interaction between the first user and the first digital assistant in a further interaction mode in the chat window corresponding to the first interaction mode, where the further interaction mode is an interaction mode other than the first interaction mode among the plurality of interaction modes

In some embodiments, the information related to the interaction includes a description of an operation performed in the further interaction mode.

In some embodiments, in the first interaction mode, the first digital assistance executes a task based on the chat message in the chat window, by using the information related to the interaction between the first user and the first digital assistant in the further interaction mode as a context, where the further interaction mode is an interaction mode other than the first interaction mode among the plurality of interaction modes.

In some embodiments, the interaction presenting module 710 includes: a second interaction presenting module configured to present, an operation panel corresponding to the first digital assistant, in accordance with a second interaction mode of the plurality of interaction modes being triggered, the operation panel including at least one of: at least one candidate shortcut instruction, or an input control for receiving an instruction, the first user issuing an instruction to the first digital assistant based on the operation panel.

In some embodiments, in the second interaction mode, the first digital assistant executes a task based on the instruction issued by the first user through the operation panel, by using the information related to the interaction between the first user and the first digital assistant in a further interaction mode as a context, where the further interaction mode is an interaction mode other than the second interaction mode among the plurality of interaction modes.

In some embodiments, the second interaction presenting module includes: an entry presenting module configured to present an entry control for the first digital assistant in a target interface area corresponding to a target content; a second interaction mode triggering module configured to determine that the second interaction mode is triggered, in response to detecting triggering for the entry control; and a post-trigger presenting module configured to present the operation panel corresponding to the first digital assistant in the target interface area.

In some embodiments, the entry control is fixedly displayed at a predetermined position of the target interface area. In some embodiments, the entry control is presented in the target interface area in response to a predetermined operation. In some embodiments, the entry control is embedded into the target content in the target interface area in accordance with a type of the target content being a predetermined type.

In some embodiments, the at least one candidate shortcut instruction in the operation panel is determined based on at least one of: at least a portion of the target content, a historical processing operation on the target content, or information related to an interaction for the target content in a further interaction mode, where the further interaction mode is an interaction mode other than the second interaction mode among the plurality of interaction modes.

In some embodiments, the apparatus 700 further includes: a result determining module configured to determine, in the second interaction mode, a processing result for a target instruction detected for the target content based on the target instruction, the target instruction including a triggered shortcut instruction of the at least one candidate shortcut instruction, or an instruction received through the input control; and a content adjusting module configured to adjust the target content based on the processing result.

In some embodiments, the content adjustment module includes: a result presenting module configured to present the processing result in the operation panel; and a post-confirmation adjustment module configured to adjust the target content based on the processing result, in response to detecting a user confirmation for the processing result.

In some embodiments, the apparatus 700 further includes: a withdrawal providing module configured to provide a withdrawal control for the adjustment.

In some embodiments, the apparatus 700 further includes: a message presenting module configured to, in accordance with the plurality of interaction modes including a first interaction mode, and an interaction area between the first user and the first digital assistant in the first interaction mode being a chat window, present a target message in the chat window corresponding to the first interaction mode, the target message at least indicating the processing result..

In some embodiments, the target message includes a first chat message corresponding to the first user and a second chat message corresponding to the first digital assistant, the first chat message indicating the target instruction, the second chat message indicating the processing result. In some embodiments, the target message includes a system message in the chat window.

In some embodiments, the target message includes an access link of the processing result, the access link being configured to link to a portion of the target content related to the processing result.

In some embodiments, the apparatus 700 further includes a reply determining module configured to determine, in the first interaction mode and based at least on the target message, a reply to a chat message input by a user.

In some embodiments, the target content includes one or more of: a document, an audio, a video, an image, an email, a calendar, a schedule, and a task.

It should be understood that one or more of the steps in the above method may be performed by an appropriate electronic device or combination of electronic devices. Such an electronic device or combination of electronic devices may include, for example, the server 130, the terminal device 110, and/or the combination of the server 130 and the terminal device 110 of FIG. 1.

FIG. 8 illustrates a block diagram of an electronic device 800 in which one or more embodiments of the present disclosure may be implemented. It should be understood that the electronic device 800 illustrated in FIG. 8 is merely example and should not constitute any limitation on the function and scope of the embodiments described herein. The electronic device 800 illustrated in FIG. 8 may be used to implement the client device 130, or the content delivery platform 110, and/or the recommendation management system 180 (or various components thereof). The electronic device 800 may include or be implemented as the apparatus 400 of FIG. 4.

As shown in FIG. 8, the electronic device 800 is in the form of a general-purpose computing device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and capable of performing various processes according to programs stored in the memory 820. In multiprocessor systems, a plurality of processing units executes computer-executable instructions in parallel to improve parallel processing capabilities of the electronic device 800.

The electronic device 800 typically includes a plurality of computer storage media. Such media may be any available media accessible to the electronic device 800, including, but not limited to, volatile and non-volatile media, removable and non-removable media. The memory 820 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, magnetic disk, or any other medium, which may be capable of storing information and/or data (e.g., training data for training) and may be accessed within the electronic device 800.

The electronic device 800 may further include additional removable/non-removable, volatile/non-volatile storage media. Although not shown in FIG. 8, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 820 may include a computer program product 828 having one or more program modules configured to perform various methods or behaviors of various embodiments of the present disclosure.

The communication unit 840 is configured to communicate with a further electronic device through a communication medium. Additionally, the function of components of the electronic device 800 may be implemented in a single computing cluster or a plurality of computing machines capable of communicating over a communication connection. Thus, the electronic device 800 may operate in a networked environment using logical connections with one or more other servers, network personal computers (PCs), or a further network node.

The input device 850 may be one or more input devices, such as a mouse, a keyboard, a trackball, or the like. The output device 860 may be one or more output devices, such as a display, a speaker, a printer, or the like. The electronic device 800 may also communicate with one or more external devices (not shown) through the communication unit 840 as needed, external devices such as storage devices, display devices, etc., communicate with one or more devices that enable a user to interact with the electronic device 800, or communicate with any device (e.g., a network card, a modem, etc.) that enables the electronic device 800 to communicate with one or more other electronic devices. Such communication may be performed via an input/output (I/O) interface (not shown).

According to example implementations of the present disclosure, a computer-readable storage medium having computer-executable instructions stored thereon is provided, the computer program, when executed by a processor, implementing the method of described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or behaviors, or may be implemented in a combination of dedicated hardware and computer instructions.

Various implementations of the present disclosure have been described above, which are example, not exhaustive, and are not limited to the implementations disclosed. Many modifications and variations would be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of information processing, comprising:
presenting, based on a triggered interaction mode of a plurality of interaction modes of a first digital assistant, an interaction area between a first user and the first digital assistant corresponding to the triggered interaction mode,
wherein interaction manners of the first user and the first digital assistant in different interaction modes are different.

2. The method of claim 1, wherein presenting the interaction area between the first user and the first digital assistant corresponding to the triggered interaction mode comprises:
simultaneously presenting, in a client interface of the first user, respective interaction areas between the first user and the first digital assistant corresponding to two or more interaction modes, in accordance with the triggered interaction mode comprising the two or more interaction modes.

3. The method of claim 1, wherein:
respective historical interaction information of the first user interacting with the first digital assistant in the plurality of interaction modes is stored in association with the first user; and
in one of the plurality of interaction modes, the first digital assistant provides a service for the first user based on the historical interaction information stored in association with the first user.

4. The method of claim 1, wherein presenting the interaction area between the first user and the first digital assistant corresponding to the triggered interaction mode comprises:
presenting a chat window between the first user and the first digital assistant, in accordance with a first interaction mode of the plurality of interaction modes being triggered, the first user interacting with the first digital assistant through a chat message in the chat window.

5. The method of claim 4, wherein the method further comprises:
presenting information related to interaction between the first user and the first digital assistant in a further interaction mode in the chat window corresponding to the first interaction mode,
wherein the further interaction mode is an interaction mode other than the first interaction mode among the plurality of interaction modes.

6. The method of claim 5, wherein the information related to the interaction comprises a description of an operation performed in the further interaction mode.

7. The method of claim 5, wherein in the first interaction mode, the first digital assistance executes a task based on the chat message in the chat window, by using the information related to the interaction between the first user and the first digital assistant in the further interaction mode as a context,
wherein the further interaction mode is an interaction mode other than the first interaction mode among the plurality of interaction modes.

8. The method of claim 1, wherein presenting the interaction area between the first user and the first digital assistant corresponding to the triggered interaction mode comprises:
presenting an operation panel corresponding to the first digital assistant, in accordance with a second interaction mode of the plurality of interaction modes being triggered, the operation panel comprising at least one of: at least one candidate shortcut instruction, or an input control for receiving an instruction, the first user issuing an instruction to the first digital assistant based on the operation panel.

9. The method of claim 8, wherein:
in the second interaction mode, the first digital assistant executes a task based on the instruction issued by the first user through the operation panel, by using the information related to the interaction between the first user and the first digital assistant in a further interaction mode as a context,
wherein the further interaction mode is an interaction mode other than the second interaction mode among the plurality of interaction modes.

10. The method of claim 8, wherein presenting the operation panel corresponding to the first digital assistant comprises:
presenting an entry control for the first digital assistant in a target interface area corresponding to a target content;
determining that the second interaction mode is triggered, in response to detecting triggerring for the entry control; and
presenting the operation panel corresponding to the first digital assistant in the target interface area.

11. The method of claim 10, wherein:
the entry control is fixedly displayed at a predetermined position of the target interface area;
or, the entry control is presented in the target interface area in response to a predetermined operation;
or, the entry control is embedded into the target content in the target interface area in accordance with a type of the target content being a predetermined type.

12. The method of claim 10, wherein the at least one candidate shortcut instruction in the operation panel is determined based on at least one of:
at least a portion of the target content,
a historical processing operation on the target content, or
information related to an interaction for the target content in a further interaction mode, wherein the further interaction mode is an interaction mode other than the second interaction mode among the plurality of interaction modes.

13. The method of claim 10, further comprising:
determining, in the second interaction mode, a processing result for a target instruction detected for the target content based on the target instruction, the target instruction comprising a triggered shortcut instruction of the at least one candidate shortcut instruction, or an instruction received through the input control; and
adjusting the target content based on the processing result.

14. The method of claim 13, wherein:
adjusting the target content based on the processing result comprises: presenting the processing result in the operation panel; and adjusting the target content based on the processing result, in response to detecting a user confirmation for the processing result;
or, the method further comprises: providing a withdrawal control for the adjustment.

15. The method of claim 13, further comprising:
in accordance with the plurality of interaction modes comprising a first interaction mode, and an interaction area between the first user and the first digital assistant in the first interaction mode being a chat window,
presenting a target message in the chat window corresponding to the first interaction mode, the target message at least indicating the processing result.

16. The method of claim 15, wherein:
the target message comprises a first chat message corresponding to the first user and a second chat message corresponding to the first digital assistant, the first chat message indicating the target instruction, the second chat message indicating the processing result;
or, the target message comprises a system message in the chat window;
or, the target message comprises an access link of the processing result, the access link being configured to link to a portion of the target content related to the processing result.

17. The method of claim 15, further comprising:
determining, in the first interaction mode and based at least on the target message, a reply to a chat message input by a user.

18. The method of claim 10, wherein the target content comprises one or more of:
a document, an audio, a video, an image, an email, a calendar, a schedule, and a task.

19. (canceled)

20. An electronic device, comprising:
at least one processor; and
at least one memory coupled to the at least one processor and storing instructions for execution by the at least one processor, the instructions, when executed by the at least one processor, causing the electronic device to perform operations comprising:
presenting, based on a triggered interaction mode of a plurality of interaction modes of a first digital assistant, an interaction area between a first user and the first digital assistant corresponding to the triggered interaction mode,
wherein interaction manners of the first user and the first digital assistant in different interaction modes are different.

21. A non-transitory computer-readable storage medium having a computer program stored thereon, the computer program being executable by a processor to implement operations comprising:
presenting, based on a triggered interaction mode of a plurality of interaction modes of a first digital assistant, an interaction area between a first user and the first digital assistant corresponding to the triggered interaction mode,
wherein interaction manners of the first user and the first digital assistant in different interaction modes are different.
